(19) United States
(12) Patent Application Publication
(10) Pub. No.: US 2025/0181123 A1
(43) Pub. Date: Jun. 5, 2025

(54) COMPUTER CHASSIS

(71) Applicant: PEGATRON CORPORATION, TAIPEI CITY (TW)

(72) Inventors: YAN-BO AN, Suzhou (CN); CHUN-YEN HUANG, TAIPEI CITY (TW); JING-BO WANG, Suzhou (CN)

(21) Appl. No.: 18/954,686

(22) Filed: Nov. 21, 2024

(30) Foreign Application Priority Data
Dec. 4, 2023 (CN) 202311652794.5

(51) Int. Cl. G06F 1/18

(52) U.S. Cl. CPC G06F 1/187; G06F 1/181

(57) ABSTRACT

A computer chassis includes a chassis, a panel covering a front plate of the chassis, a carrying frame assembled to two lateral plates of the chassis, and an optical disc drive (ODD) that is assembled to the carrying frame. The carrying frame has a first arrangement angle, a second arrangement angle, and a third arrangement angle with respect to the chassis. When the carrying frame is at the first arrangement angle, the carrying frame is detachable from the chassis. When the carrying frame is at the second arrangement angle, the carrying frame abuts against the front plate and is movable away from the front plate. When the carrying frame is at the third arrangement angle, the carrying frame is movable toward the front plate and a surface of the ODD is flushed with the panel through an opening of the panel.

### CROSS-REFERENCE TO RELATED PATENT APPLICATION

This application claims the benefit of priority to China Patent Application No. 202311652794.5, filed on Dec. 4, 2023, in the People's Republic of China. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a chassis, and more particularly to a computer chassis.

### BACKGROUND OF THE DISCLOSURE

An optical disc drive (ODD) is assembled to a conventional computer chassis through tools and screws that cooperate with a structural configuration of the conventional computer chassis. However, this configuration of the conventional computer chassis causes the ODD to be difficult to be assembled to or disassembled from the conventional computer chassis. Furthermore, the ODD cannot be assembled or disassembled in lack of a specialized tool for the purpose.

### SUMMARY OF THE DISCLOSURE

In response to the above-referenced technical inadequacies, the present disclosure provides a computer chassis for effectively improving on the issues associated with a conventional computer chassis.

In order to solve the above-mentioned problems, one of the technical aspects adopted by the present disclosure is to provide a computer chassis, which includes: a chassis, a panel, a carrying frame, and an optical disc drive (ODD). The chassis includes a bottom plate, two lateral plates, a front plate, and a rear plate. The two lateral plates face toward each other and are connected to the bottom plate. Each of the two lateral plates has a sliding slot having a slot end. The front plate and the rear plate face toward each other and are connected to the bottom plate and the two lateral plates. The bottom plate, the two lateral plates, the front plate, and the rear plate jointly define an accommodating space. The panel covers the front plate and has an opening, and the panel and the front plate are parallel to each other. The carrying frame is arranged in the accommodating space and is assembled to the sliding slots of the two lateral plates. The carrying frame has two pivotal shafts and an abutting structure, and the carrying frame has a first arrangement angle, a second arrangement angle, and a third arrangement angle with respect to the chassis. The second arrangement angle is between the first arrangement angle and the third arrangement angle. The ODD is detachably assembled to the carrying frame. When the carrying frame is at the first arrangement angle, each of the two pivotal shafts of the carrying frame is arranged in one of the sliding slots and is slidable in a direction away from the slot end of the corresponding sliding slot, thereby allowing the carrying frame to be detached and separated from the chassis. When the carrying frame is at the second arrangement angle, the abutting structure abuts against the front plate, such that each of the two pivotal shafts moves in a direction from the corresponding slot end toward the rear plate. When the carrying frame is at the third arrangement angle, each of the two pivotal shafts of the carrying frame is movable toward the corresponding slot end and a surface of the ODD is flushed with the panel through the opening.

Therefore, the computer chassis of the present disclosure is provided with the cooperation between the carrying frame and the chassis (e.g., when the carrying frame is at the second arrangement angle, the abutting structure abuts against the front plate, such that each of the two pivotal shafts moves in a direction from the corresponding slot end toward the rear plate), thereby effectively preventing the ODD (or the carrying frame) from interfering with the front plate during assembling or disassembling operation. Accordingly, it can be quickly achieved by a manual operation during the assembling to or disassembling the carrying frame from the chassis.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic exploded view of a computer chassis according to an embodiment of the present disclosure;

FIG. 2 is a schematic exploded view of the computer chassis when an optical disc drive (ODD) and a hard disk drive (HDD) are assembled to a carrying frame according to the embodiment of the present disclosure;

FIG. 3 is a schematic perspective view showing the computer chassis when the carrying frame is at a first arrangement angle according to the embodiment of the present disclosure;

FIG. 4 is a schematic perspective cross-sectional view showing the computer chassis when the carrying frame is at the first arrangement angle according to the embodiment of the present disclosure;

FIG. 5 is a schematic perspective cross-sectional view showing the computer chassis when the carrying frame is at a second arrangement angle according to the embodiment of the present disclosure;

FIG. 6 is a schematic planar cross-sectional view of a part of FIG. 5;

FIG. 7 is a schematic perspective cross-sectional view showing the computer chassis when the carrying frame is at a third arrangement angle and at an intermediary position according to the embodiment of the present disclosure;

FIG. 8 is a schematic planar cross-sectional view of a part of FIG. 7;

FIG. 9 is a schematic perspective cross-sectional view showing the computer chassis when the carrying frame is at the third arrangement angle and at a fixing position according to the embodiment of the present disclosure; and

FIG. 10 is a schematic planar cross-sectional view of a part of FIG. 9.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

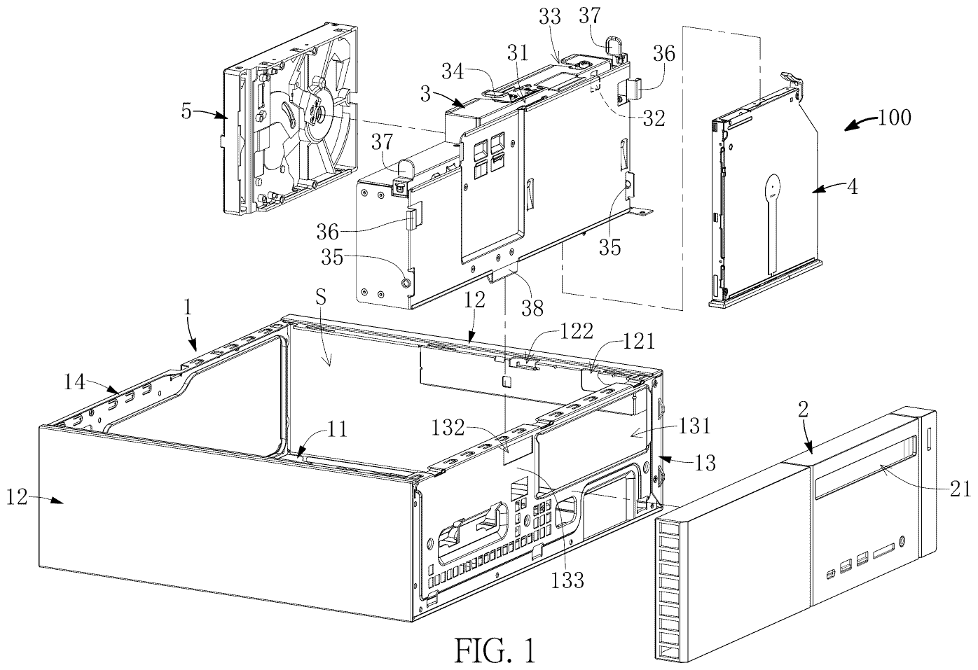

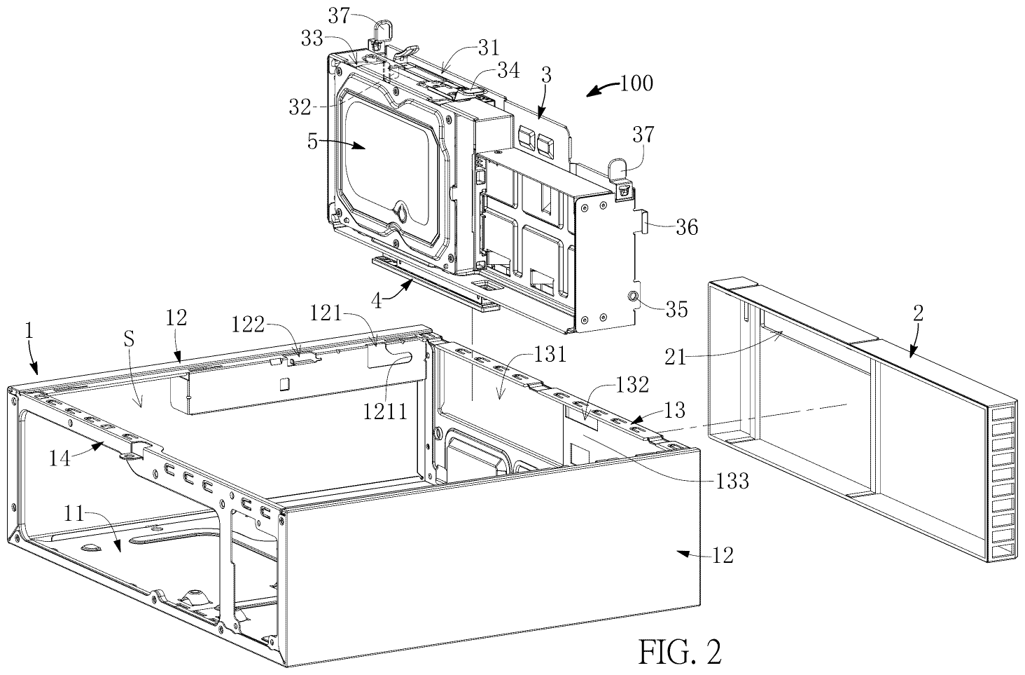

Referring to FIG. 1 to FIG. 10, an embodiment of the present disclosure is provided. As shown in FIG. 1 to FIG. 3, the present embodiment provides a computer chassis 100, which includes a chassis 1, a panel 2 covering the chassis 1, a carrying frame 3 detachably assembled in the chassis 1, an optical disc drive (ODD) 4 detachably assembled to the carrying frame 3, and a hard disk driver (HDD) 5 that is detachably assembled to the carrying frame 3, but the present disclosure is not limited thereto. For example, in other embodiments of the present disclosure not shown in the drawings, the HDD 5 of the computer chassis 100 can be omitted according to design requirements.

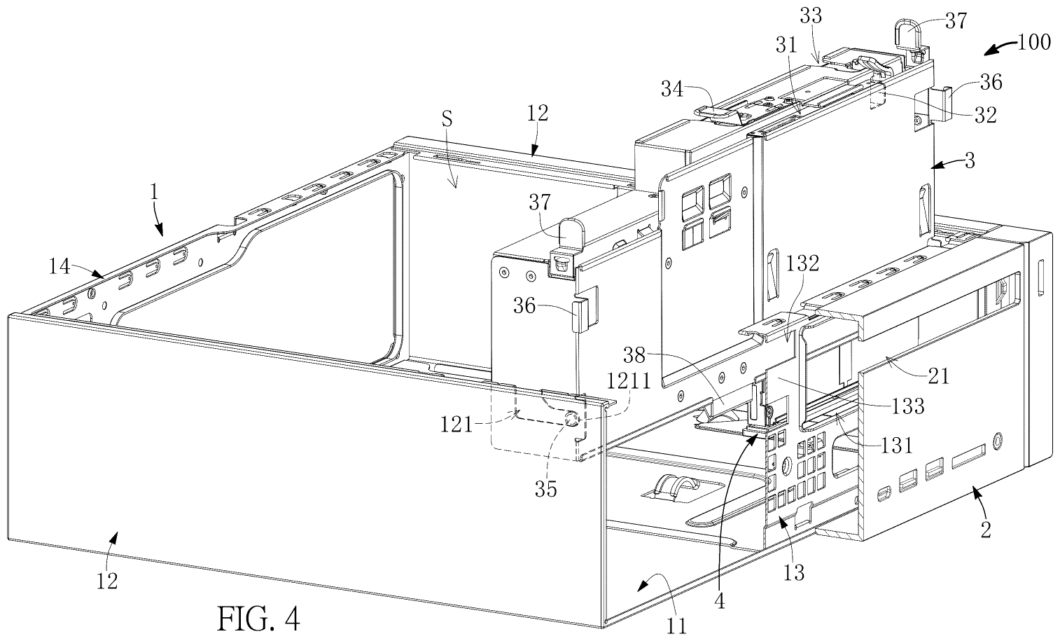

As shown in FIG. 1 and FIG. 4 of the present embodiment, the chassis 1 includes a bottom plate 11, two lateral plates 12, a front plate 13, and a rear plate 14. The two lateral plates 12 face toward each other and are connected to the bottom plate 11, and the front plate 13 and the rear plate 14 face toward each other and are connected to the bottom plate 11. The bottom plate 11 is configured to allow a circuit board (not shown in the drawings) to be disposed thereon. The front plate 13 is connected to front ends of the two lateral plates 12, and the rear plate 14 is connected to rear ends of the two lateral plates 12, such that the two lateral plates 12, the front plate 13, and the rear plate 14 are connected to each other for jointly forming a rectangular ring-shaped structure that is connected to a peripheral edge of the bottom plate 11.

Accordingly, the two lateral plates 12, the front plate 13, and the rear plate 14 jointly form an accommodating space S that has a slot-like shape. Moreover, the chassis 1 further includes a covering plate (not shown in the drawings) facing toward the bottom plate 11, and the covering plate can be detachably assembled to the two lateral plates 12, the front plate 13, and the rear plate 14, thereby enclosing the accommodating space S.

Specifically, each of the two lateral plates 12 has a sliding slot 121 and a limiting slot 122. The sliding slot 121 and the limiting slot 122 of one of the two lateral plates 12 respectively face toward and are symmetrical to the sliding slot 121 and the limiting slot 122 of another one of the two lateral plates 12. In each of the two lateral plates 12, the sliding slot 121 has a slot end 1211 arranged adjacent to the front plate 13, and the sliding slot 121 is arranged between he front plate 13 and the limiting slot 122.

In addition, the front plate 13 has an ODD opening 131 and a receiving opening 132 that is arranged adjacent to the ODD opening 131. The front plate 13 further has a stop portion 133 arranged adjacent to the receiving opening 132. The stop portion 133 is located closer to the bottom plate 11 than the receiving opening 132. In other words, the stop portion 133 is located directly under the receiving opening 132.

The panel 2 covers the front plate 13, and the panel 2 and the front plate 13 are parallel to each other. The panel 2 has an opening 21 corresponding in position to the ODD opening 131, and the accommodating space S is in spatial communication with an external space through the ODD opening 131 and the opening 21. It should be noted that each of the ODD opening 131 and the opening 21 corresponds in shape to a cross section of the ODD 4, so that each of the ODD opening 131 and the opening 21 allows the ODD 4 to pass therethrough.

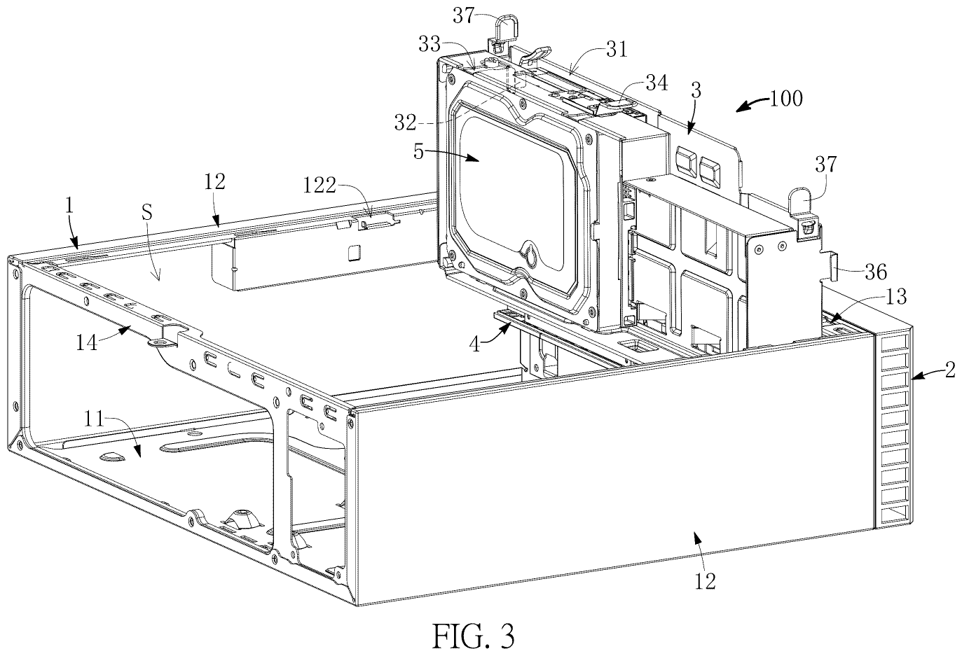

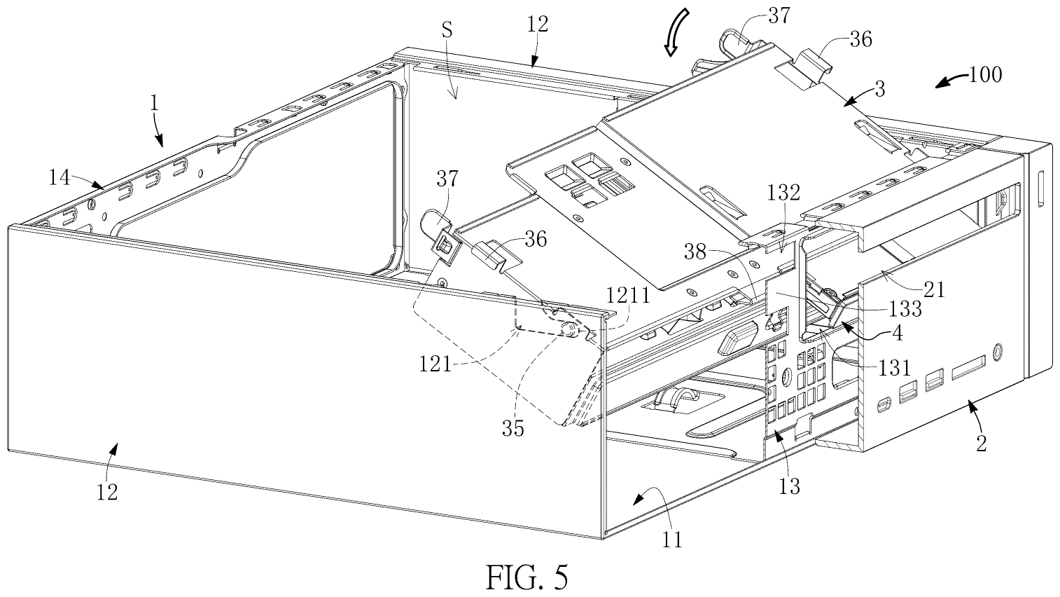

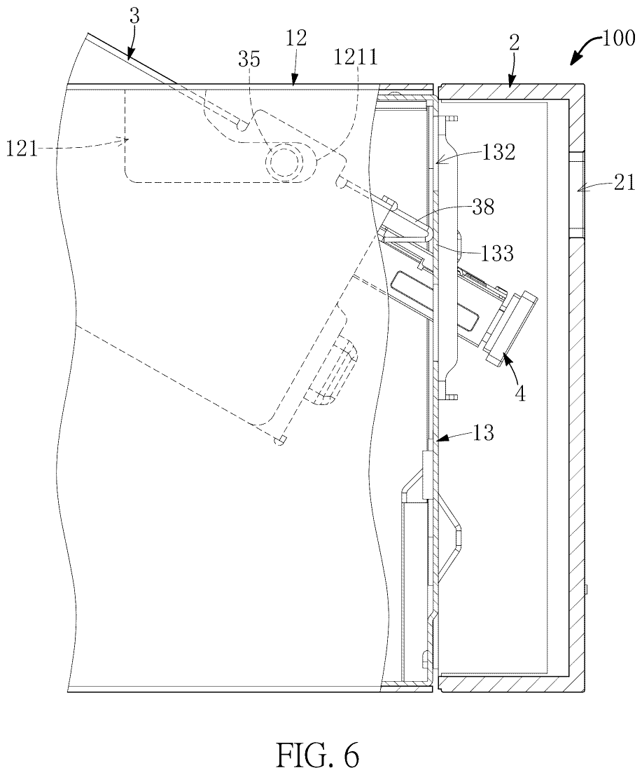

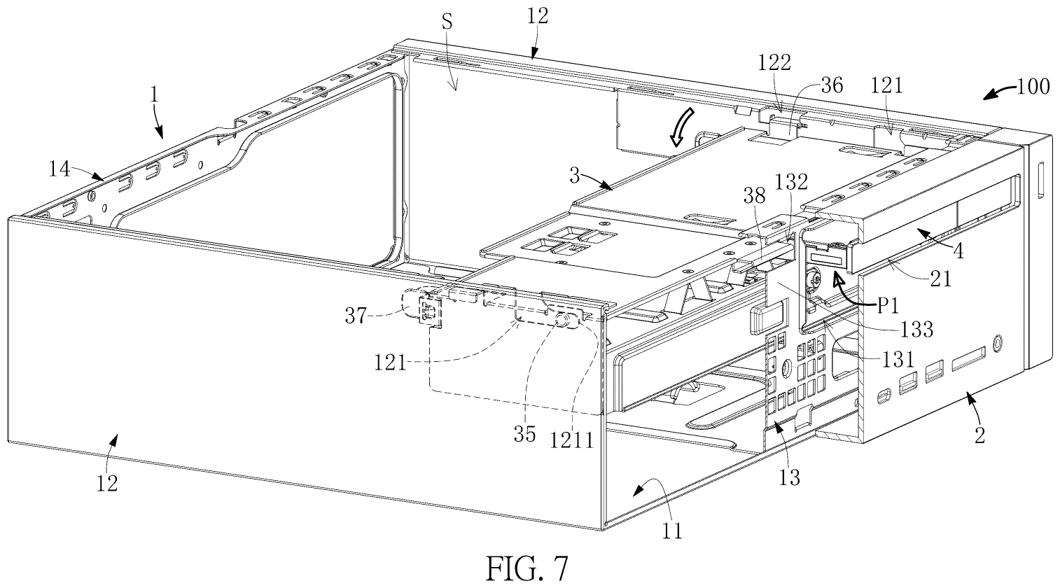

The carrying frame 3 is arranged in the accommodating space S and is assembled to the sliding slots 121 of the two lateral plates 12, so that the carrying frame 3 is rotatable relative to the chassis 1. In the present embodiment, the carrying frame 3 has a first arrangement angle (as shown in FIG. 3 and FIG. 4), a second arrangement angle (as shown in FIG. 5 and FIG. 6), and a third arrangement angle (as shown in FIG. 7 to FIG. 10) with respect to the chassis 1.

When the carrying frame 3 is at the first arrangement angle (as shown in FIG. 3 and FIG. 4), the carrying frame 3 is perpendicular to the bottom plate 11, and most of a volume of the carrying frame 3 is located outside of the accommodating space S. When the carrying frame 3 is at the third arrangement angle (as shown in FIG. 7 to FIG. 10), the carrying frame 3 is parallel to the bottom plate 11, and almost all of the volume of the carrying frame 3 is located in the accommodating space S. The second arrangement angle (e.g., 30 degrees) is between the first arrangement angle (e.g., 90 degrees) and the third arrangement angle (e.g., 0 degrees).

As shown in FIG. 1 to FIG. 10, in order to clearly describe the operation of the computer chassis 100 of the present embodiment, the following description describes the structure and connection relationship of the carrying frame 3, and then describes the operation and other connection relationships of the carrying frame 3 when being at the first arrangement angle, the second arrangement angle, and the third arrangement angle.

As shown in FIG. 1 and FIG. 4 of the present embodiment, the carrying frame 3 defines an ODD space 31 for receiving the ODD 4 and an HDD space 33 for receiving the HDD 5 that is arranged adjacent to the ODD space 31. The carrying frame 3 includes an ODD locking portion 32 corresponding in position to the ODD space 31 and an HDD locking member 34 that corresponds in position to the HDD space 33. The ODD 4 is locked and fixed in the ODD space 31 of the carrying frame 3 through the ODD locking portion 32 (e.g., the ODD locking portion 32 is engaged with the ODD 4 through an elastic arm thereof), and the HDD 5 is locked and fixed in the HDD space 33 of the carrying frame 3 through the HDD locking member 34.

It should be noted that, the cooperation between the ODD locking portion 32 and the ODD 4 and the cooperation between the HDD locking member 34 and the HDD 5 in the present embodiment are achieved by a manual operation (e.g., the foregoing cooperations may be achieved by using elastic structures or sliding structures to engage or position with each other) without the use of any tool, thereby facilitating assembling or disassembling of each of the ODD 4 and the HDD 5 with respect to the carrying frame 3, but the present disclosure is not limited thereto.

Specifically, the carrying frame 3 includes two pivotal shafts 35, two limiting arms 36, two frame locking members 37, and an abutting structure 38. The two pivotal shafts 35 are respectively arranged on two lateral sides of the carrying frame 3, the two limiting arms 36 are respectively arranged on the two lateral sides of the carrying frame 3, and the two frame locking members 37 are respectively arranged on the two lateral sides of the carrying frame 3. In other words, any one of the two lateral sides of the carrying frame 3 is formed with one of the two pivotal shafts 35, one of the two limiting arms 36, and one of the two frame locking members 37, the limiting arm 36 being located between the pivotal shaft 35 and the frame locking member 37, but the present disclosure is not limited thereto.

Moreover, the abutting structure 38 is arranged on a substantial center portion of a front side of the carrying frame 3, and the abutting structure 38 is a protrusion. The abutting structure 38 can be selectively abutted against the front plate 13 (e.g., the stop portion 133) or received in the receiving opening 132 according to an arrangement angle (e.g., the second arrangement angle or the third arrangement angle) of the carrying frame 3.

It should be noted that, the carrying frame 3 and any structures formed thereon can be manufactured by bending a metal plate to form a frame body and further punching and bending the metal plate to form other structures (e.g., the ODD locking portion 32, the two pivotal shafts 35, the limiting arms 36, and the abutting structure 38) or further assembling components (e.g., the HDD locking member 34 and the two frame locking members 37) to the frame body, but the present disclosure is not limited thereto.

In summary, as shown in FIG. 3 and FIG. 4, when the carrying frame 3 is at the first arrangement angle, each of the two pivotal shafts 35 of the carrying frame 3 is arranged in one of the sliding slots 121 of the two lateral plates 12 and is slidable in a direction away from the slot end 1211 of the corresponding sliding slot 121, thereby allowing the carrying frame 3 to be detached and separated from the chassis 1 and allowing the HDD 5 to be assembled to or disassembled from the HDD space 33 of the carrying frame 3.

As shown in FIG. 5 and FIG. 6, when the carrying frame 3 is at the second arrangement angle, the abutting structure 38 abuts against the front plate 13 (e.g., the stop portion 133 of the front plate 13), such that each of the two pivotal shafts 35 moves from the corresponding slot end 1211 toward the rear plate 14.

Specifically, as shown in FIG. 3 to FIG. 6, when the carrying frame 3 is rotated from the first arrangement angle to the second arrangement angle, the abutting structure 38 of the carrying frame 3 abuts against the front plate 13 so as to enable each of the two pivotal shafts 35 to be spaced apart from the corresponding slot end 1211 by a distance, thereby preventing the ODD 4 (or the front side of the carrying frame 3) from impacting or interfering with the front plate 13.

In other words, when the carrying frame 3 is rotated from the first arrangement angle toward the second arrangement angle, since the abutting structure 38 abuts against the front plate 13, each of the two pivotal shafts 35 adjacent to the corresponding slot end 1211 is moved in a direction away from the corresponding slot end 1211.

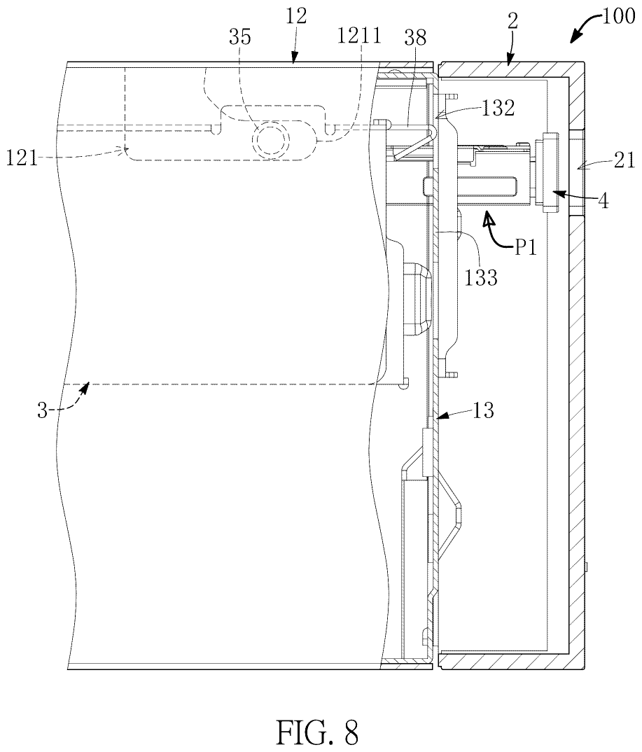

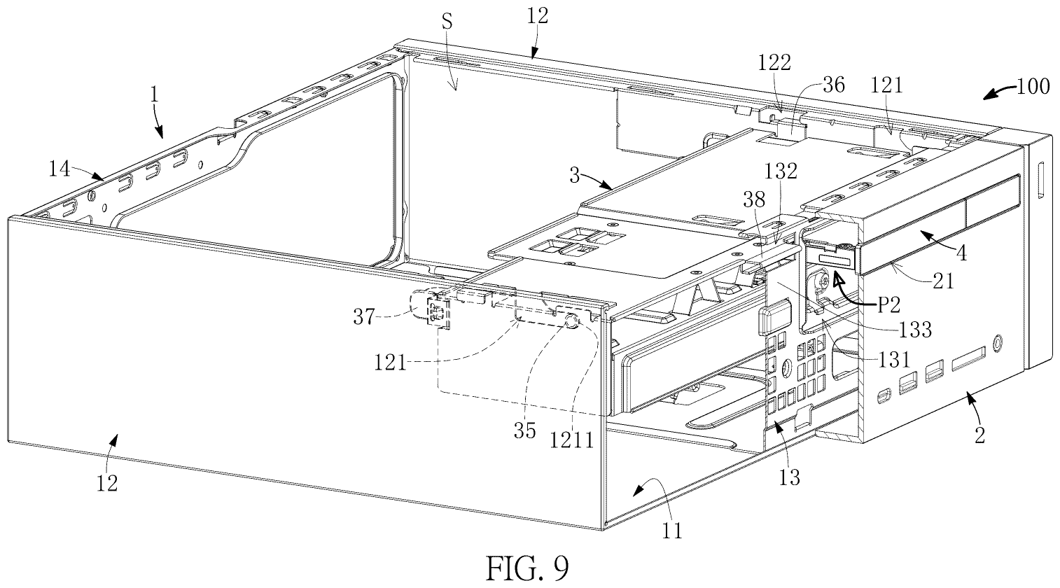

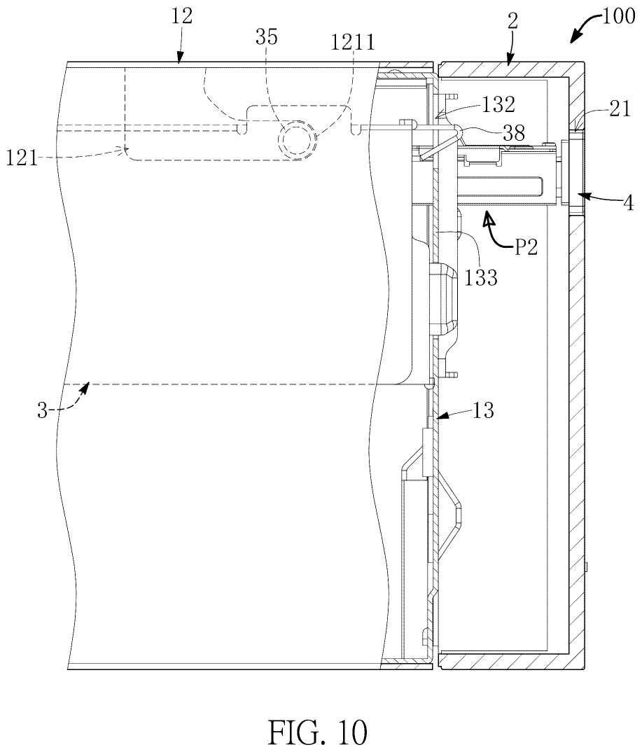

As shown in FIG. 7 to FIG. 10, when the carrying frame 3 is at the third arrangement angle, a user can move the carrying frame 3 from an intermediary position P1 (as shown in FIG. 7 and FIG. 8) to a fixing position P2 (as shown in FIG. 9 and FIG. 10), such that the two limiting arms 36 can be respectively assembled to the limiting slots 122 of the two lateral plates 12, and each of the two pivotal shafts 35 of the carrying frame 3 is movable toward the corresponding slot end 1211. Accordingly, the ODD 4 passes through the ODD opening 131 and a surface of ODD 4 is flushed with the panel 2 through the opening 21, and the abutting structure 38 passes through the receiving opening 132 and is partially received in the receiving opening 132.

Specifically, as shown in FIG. 7 and FIG. 8, when the carrying frame 3 is at the intermediary position P1, each of the two pivotal shafts 35 is located away from the corresponding slot end 1211, the ODD 4 passes through the ODD opening 131, and the abutting structure 38 protrudes from the front plate 13 through the receiving opening 132. In other words, the abutting structure 38 is corresponding in shape to the receiving opening 132, so that the abutting structure 38 is able to pass therethrough the receiving opening 132.

When the carrying frame 3 is moved from the intermediary position P1 to the fixing position P2, the frame locking members 37 of the carrying frame 3 are respectively locked to the two lateral plates 12 of the chassis 1. Accordingly, when the carrying frame 3 is at the fixing position P2, each of the two pivotal shafts 35 is located on the corresponding slot end 1211 and a surface of the ODD 4 is flushed with the panel 2 through the opening 21, and the abutting structure 38 is protruded from the receiving opening 132.

It should be noted that, when the carrying frame 3 is at the fixing position P2 and the ODD locking portion 32 is unlocked, the ODD 4 is configured to be removable from the opening 21 of the panel 2, thereby facilitating assembling or disassembling of the ODD 4 by the user. Moreover, the assembling or disassembling of the ODD 4 can be achieved by a manual operation without use of any tool.

### Beneficial Effects of the Embodiment

In conclusion, the computer chassis of the present disclosure is provided with the cooperation between the carrying frame and the chassis (e.g., when the carrying frame is at the second arrangement angle, the abutting structure abuts against the front plate, such that each of the two pivotal shafts moves from the corresponding slot end toward the rear plate), thereby effectively preventing the ODD (or the carrying frame) from interfering with the front plate during assembling or disassembling operation. Accordingly, it can be quickly achieved by a manual operation during the assembling to or disassembling the carrying frame from the chassis.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A computer chassis, comprising:
a chassis including:
a bottom plate;
two lateral plates facing toward each other and connected to the bottom plate, wherein each of the two lateral plates has a sliding slot having a slot end; and
a front plate and a rear plate that face toward each other and that are connected to the bottom plate and the two lateral plates, wherein the bottom plate, the two lateral plates, the front plate, and the rear plate jointly define an accommodating space;
a panel covering the front plate and having an opening, wherein the panel and the front plate are parallel to each other;
a carrying frame arranged in the accommodating space and assembled to the sliding slots of the two lateral plates, wherein the carrying frame has two pivotal shafts and an abutting structure, and the carrying frame has a first arrangement angle, a second arrangement angle, and a third arrangement angle with respect to the chassis, and wherein the second arrangement angle is between the first arrangement angle and the third arrangement angle; and
an optical disc drive (ODD) detachably assembled to the carrying frame;
wherein, when the carrying frame is at the first arrangement angle, each of the two pivotal shafts of the carrying frame is arranged in one of the sliding slots and is slidable in a direction away from the slot end of the corresponding sliding slot, thereby allowing the carrying frame to be detached and separated from the chassis;
wherein, when the carrying frame is at the second arrangement angle, the abutting structure abuts against the front plate, such that each of the two pivotal shafts moves in a direction from the corresponding slot end toward the rear plate;
wherein, when the carrying frame is at the third arrangement angle, each of the two pivotal shafts of the carrying frame is movable toward the corresponding slot end and a surface of the ODD is flushed with the panel through the opening.

2. The computer chassis according to claim 1, wherein, when the carrying frame is at the first arrangement angle, the carrying frame is perpendicular to the bottom plate, and wherein, when the carrying frame is at the third arrangement angle, the carrying frame is parallel to the bottom plate.

3. The computer chassis according to claim 1, wherein, when the carrying frame is at the third arrangement angle, the carrying frame has an intermediary position and a fixing position, wherein, when the carrying frame is at the intermediary position, each of the two pivotal shafts is located away from the corresponding slot end, and wherein, when the carrying frame is at the fixing position, each of the two pivotal shafts is located on the corresponding slot end, and the surface of the ODD is flushed with the panel through the opening.

4. The computer chassis according to claim 3, wherein the carrying frame includes two frame locking members, and wherein, when the carrying frame is at the fixing position, the frame locking members of the carrying frame are respectively locked to the two lateral plates of the chassis.

5. The computer chassis according to claim 3, wherein the carrying frame has an ODD space for receiving the ODD and includes an ODD locking portion, and wherein the ODD is locked and fixed in the ODD space of the carrying frame through the ODD locking portion.

6. The computer chassis according to claim 5, wherein, when carrying frame is at the fixing position and the ODD locking portion is unlocked, the ODD is configured to be removable from the opening of the panel.

7. The computer chassis according to claim 1, further comprising a hard disk drive (HDD), wherein the carrying frame defines an HDD space for receiving the HDD, and wherein, when the carrying frame is at the first arrangement angle, the HDD is detachably assembled in the HDD space of the carrying frame.

8. The computer chassis according to claim 7, wherein the carrying frame includes an HDD locking member, and wherein the HDD is locked and fixed in the HDD space of the carrying frame through the HDD locking member.

9. The computer chassis according to claim 1, wherein the carrying frame includes two limiting arms, each of the two lateral plates of the chassis has a limiting slot, and the two limiting arms are respectively assembled to the limiting slots of the two lateral plates.

10. The computer chassis according to claim 1, wherein, when the carrying frame is at the third arrangement angle, the abutting structure is received in a receiving opening of the front plate and protrudes from the front plate through the receiving opening.
